(19) United States
(12) Patent Application Publication
(10) Pub. No.: US 2019/0114023 A1
(43) Pub. Date: Apr. 18, 2019

(54) TOUCH PANEL-EQUIPPED DISPLAY DEVICE

(71) Applicant: SHARP KABUSHIKI KAISHA, Sakai City, Osaka (JP)

(72) Inventors: TOSHIMITSU GOTOH, Sakai City (JP); DAIJI KITAGAWA, Sakai City (JP)

(21) Appl. No.: 16/087,633

(22) PCT Filed: Mar. 22, 2017
(86) PCT No.: PCT/JP2017/011352

§ 371 Date: Sep. 21, 2018

(30) Foreign Application Priority Data
Mar. 23, 2016 (JP) 2016-059289

(51) Int. Cl. G06F 3/041; G02F 1/1333; G02F 1/1362; G02F 1/133

(52) U.S. Cl. CPC G06F 3/0416; G02F 1/13338; G06F 3/0412; G02F 1/136213; G02F 1/13306; G02F 1/136286

(57) ABSTRACT

Provided is an in-cell-type touch-panel-equipped display device that can perform a touch position detection operation without being influenced by potential fluctuations due to image display. The touch-panel-equipped display device includes a plurality of counter electrodes that, together with pixel electrode, form electrostatic capacitances therebetween, and touch sensor lines connected to the counter electrodes. During one scanning operation, a controller supplies a sensor driving signal to the touch sensor lines connected to the counter electrodes of one segment, among the counter electrodes, one segment being composed of a series of the counter electrodes arrayed in a first direction in which gate lines extend. Further, the controller, after supplying the selection signal to at least a part of the gate lines, supplies the sensor driving signal to the touch sensor line connected to the counter electrode of the segment at a position far from the gate line to which the selection signal is supplied last.

### TECHNICAL FIELD

The present invention relates to a touch-panel-equipped display device, particularly to an in-cell-type touch-panel-equipped display device.

### BACKGROUND ART

In recent years, a display device that incorporates a touch panel is widely used. Lately in particular, a so-called in-cell-type touch-panel-equipped display device that incorporates sensing electrodes and lines for detecting a touch in the inside is known. An example of such an in-cell-type touch-panel-equipped display device is disclosed in Patent Document 1 indicated below.

### PRIOR ART DOCUMENT

### Patent Document

### Patent Document 1: JP-B-5665957

### SUMMARY OF THE INVENTION

### Problem to be Solved by the Invention

In a conventional in-cell-type touch-panel-equipped display device, generally, a plurality of touch sensor lines for supplying a sensor driving signal to sensing electrodes are provided so as to extend in a direction that intersects at right angles with gate lines, and these touch sensor lines are sequentially driven in the order along the direction in which the gate lines extend, so that a touch position is detected.

At a portion where the touch sensor line that is being driven intersects with the gate line to which a selection signal is being applied, the sensor capacity therefore increases, thereby causing noise to appear in the touch position detection results in some cases.

Patent Document 1 described above discloses a configuration in which one frame period is divided into a period while the panel is driven in the display driving mode and a period while the panel is driven in the touch driving mode. Such time-divided driving with use of the display driving mode and the touch driving mode does not make it possible to completely avoid influences of noises. This is because a portion of the gate lines to which the selection signal is applied in the display driving mode is influenced by the display for a certain period, too, after the display is ended.

In light of the above-described problem, it is an object of the present invention to make it possible to perform a touch position detection operation without being influenced by potential fluctuations due to image display in an in-cell-type touch-panel-equipped display device.

### Means to Solve the Problem

To solve the above-described problem, a touch-panel-equipped display device disclosed herein includes: an active matrix substrate; a counter substrate opposed to the active matrix substrate; and a liquid crystal layer interposed between the active matrix substrate and the counter substrate. The active matrix substrate includes: a plurality of gate lines extending in a first direction; a plurality of data lines extending in a second direction that intersects with the first direction; display control elements connected to the gate lines and the data lines; a plurality of pixel electrodes connected to the display control elements; a plurality of counter electrodes that, together with pixel electrodes, form electrostatic capacitances therebetween; and touch sensor lines connected to the counter electrodes. The touch-panel-equipped display device further includes: a controller that controls a timing of supplying a sensor driving signal to the touch sensor lines, and a timing of supplying a selection signal to the gate lines. During one vertical period, the controller performs the supply of the selection signal to the gate lines, and the supply of the sensor driving signal to the touch sensor lines, in a time-division manner. Further, during one scanning operation, the controller supplies the sensor driving signal to the touch sensor lines connected to the counter electrodes of one segment, among the counter electrodes, one segment being composed of a series of the counter electrodes arrayed in the first direction. Still further, the controller, after supplying the selection signal to at least a part of the gate lines, supplies the sensor driving signal to the touch sensor line connected to the counter electrode of the segment at a position far from the gate line to which the selection signal is supplied last.

### Effect of the Invention

With the present invention, it is possible to provide a touch-panel-equipped display device that can perform a touch position detection operation without being influenced by potential fluctuations due to image display.

### BRIEF DESCRIPTION OF DRAWINGS

FIG. 1 is a cross-sectional view illustrating a schematic configuration of a touch-panel-equipped display device of Embodiment 1.

FIG. 2 is a schematic plan view illustrating an exemplary line arrangement for counter electrodes formed on an active matrix substrate.

FIG. 3 is an enlarged view of a part of the active matrix substrate.

FIG. 4 is a schematic plan view illustrating a state where counter electrodes are divided into segments.

FIG. 5 is a timing chart illustrating timings of a control signal that a controller supplies to gate lines and touch sensor lines.

FIG. 6 is a timing chart illustrating timings of a control signal that a controller of Embodiment 2 supplies to gate lines and touch sensor lines.

FIG. 7 is a timing chart illustrating timings of a control signal that a controller of Embodiment 3 supplies to gate lines and touch sensor lines.

FIG. 8 is a timing chart illustrating timings of a control signal that a controller of Embodiment 4 supplies to gate lines and touch sensor lines.

FIG. 9 is a timing chart illustrating timings of a control signal that a controller of Embodiment 5 supplies to gate lines and touch sensor lines.

FIG. 10 is a schematic plan view illustrating a modification example of the touch-panel-equipped display device.

### MODE FOR CARRYING OUT THE INVENTION

A touch-panel-equipped display device according to the first configuration of the present invention includes: an active matrix substrate; a counter substrate opposed to the active matrix substrate; and a liquid crystal layer interposed between the active matrix substrate and the counter substrate, wherein the active matrix substrate includes: a plurality of gate lines extending in a first direction; a plurality of data lines extending in a second direction that intersects with the first direction; display control elements connected to the gate lines and the data lines; a plurality of pixel electrodes connected to the display control elements; a plurality of counter electrodes that, together with pixel electrodes, form electrostatic capacitances therebetween; and touch sensor lines connected to the counter electrodes.

The touch-panel-equipped display device further includes: a controller that controls a timing of supplying a sensor driving signal to the touch sensor lines, and a timing of supplying a selection signal to the gate lines. During one vertical period, the controller performs the supply of the selection signal to the gate lines, and the supply of the sensor driving signal to the touch sensor lines, in a time-division manner. Further, during one scanning operation, the controller supplies the sensor driving signal to the touch sensor lines connected to the counter electrodes of one segment, among the counter electrodes, one segment being composed of a series of the counter electrodes arrayed in the first direction. Still further, the controller, after supplying the selection signal to at least a part of the gate lines, supplies the sensor driving signal to the touch sensor line connected to the counter electrode of the segment at a position far from the gate line to which the selection signal is supplied last.

According to this configuration, the sensor driving signal is supplied to the touch sensor line connected to the counter electrode of the segment at a position far from the gate line to which the selection signal is supplied last, whereby a touch position detection operation can be performed without being influenced by potential fluctuations of the gate lines due to image display.

A touch-panel-equipped display device according to a second configuration of the present invention has the first configuration further characterized in that the number of the segments is n (n is a natural number of 2 or more), so that the counter electrodes are divided into the n segments, and the gate lines are divided into n groups. Further, during one vertical period, the controller alternately performs the supply of the selection signal to the gate lines belonging to one of the groups, and the supply of the sensor driving signal to the touch sensor lines connected to the counter electrodes of one of the segments.

According to this configuration, after the selection signal is supplied to the gate lines belonging to one of the groups, the sensor driving signal is supplied to the touch sensor line connected to the counter electrode of one segment at a position far from the gate line to which the selection signal is supplied last. Thereby, a touch position detection operation can be performed without being influenced by potential fluctuations of the gate lines due to image display

A touch-panel-equipped display device according to a third configuration of the present invention has the first configuration further characterized in that, during one vertical period, after supplying the selection signal to all of the gate lines, the controller supplies the sensor driving signal to the touch sensor lines connected to the counter electrodes of the segment at the position farthest from the gate line to which the selection signal is supplied last.

According to this configuration, after the selection signal is supplied to all of the gate lines, the sensor driving signal is supplied to the touch sensor lines connected to the counter electrodes of the segment at the position farthest from the gate line to which the selection signal is supplied last. Thereby, a touch position detection operation can be performed without being influenced by potential fluctuations of the gate lines due to image display.

A touch-panel-equipped display device according to a fourth configuration of the present invention has the first configuration further characterized in that the number of the segments is n (n is a natural number of 2 or more), so that the counter electrodes are divided into the n segments, and the gate lines are divided into n groups. Further, during one vertical period, the controller alternately performs the supply of the selection signal to the gate lines belonging to one of the groups, and the supply of the sensor driving signal to the touch sensor lines connected to the counter electrodes of two or more of the segments.

According to this configuration, after the selection signal is supplied to the gate lines belonging to one of the groups, the sensor driving signal is supplied to the touch sensor line connected to the counter electrode of the segment at a position far from the gate line to which the selection signal is supplied last. Thereby, a touch position detection operation can be performed without being influenced by potential fluctuations of the gate lines due to image display.

A touch-panel-equipped display device according to a fifth configuration of the present invention has the first configuration further characterized in that the gate lines are divided into m groups (m is a natural number of 2 or more). Further, during one vertical period, the controller alternately performs the supply of the selection signal to the gate lines belonging to one of the groups, and the supply of the sensor driving signal to the touch sensor lines connected to the counter electrodes of all of the segments.

According to this configuration, after the selection signal is supplied to the gate lines belonging to one of the groups, the sensor driving signal is supplied to the touch sensor line connected to the counter electrode of the segment at a position far from the gate line to which the selection signal is supplied last. Thereby, a touch position detection operation can be performed without being influenced by potential fluctuations of the gate lines due to image display.

### EMBODIMENT

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### Embodiment 1

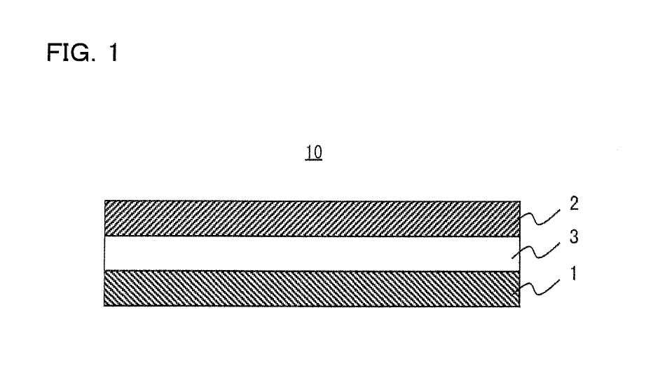

FIG. 1 is a cross-sectional view of a touch-panel-equipped display device 10 of one embodiment. The touch-panel-equipped display device 10 in one embodiment includes an active matrix substrate 1, a counter substrate 2, and a liquid crystal layer 3 interposed between the active matrix substrate 1 and the counter substrate 2. Each of the active matrix substrate 1 and the counter substrate 2 includes a glass substrate that is substantially transparent (has high translucency). The counter substrate 2 includes color filters that are not illustrated. Further, though the illustration is omitted, this touch-panel-equipped display device 10 includes a backlight.

The touch-panel-equipped display device 10 in the present embodiment has a function of displaying an image, and at same time, has a function of detecting position information (touch position) input by a user based on the displayed image. This touch-panel-equipped display device 10 includes a so-called in-cell type touch panel in which lines and the like that are required for detecting a touch position are formed in a display panel.

In the case of the touch-panel-equipped display device 10 in the present embodiment, the method for driving liquid crystal molecules contained in the liquid crystal layer 3 is the horizontal electric field driving method. In order to realize the horizontal electric field driving method, pixel electrodes and counter electrodes (referred to as “common electrodes” in some cases) for forming electric fields are formed on the active matrix substrate 1.

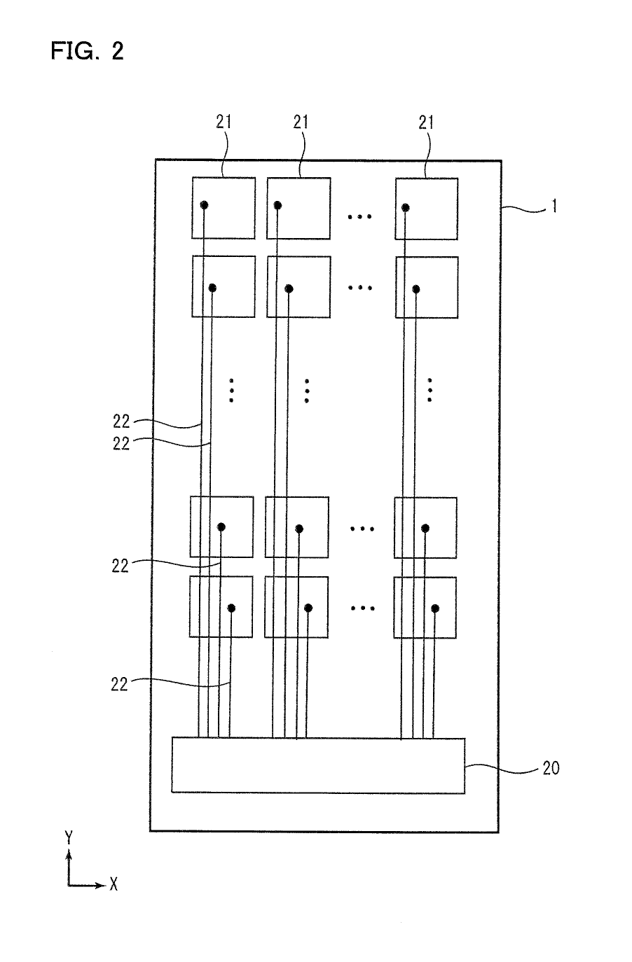

FIG. 2 illustrates an exemplary arrangement of counter electrodes 21 formed on the active matrix substrate 1. The counter electrodes 21 are formed on a surface on the liquid crystal layer 3 side of the active matrix substrate 1. As illustrated in FIG. 2, the counter electrode 21 is in a rectangular shape, and a plurality of the counter electrodes 21 are arranged in matrix on the active matrix substrate 1.

On the active matrix substrate 1, a controller 20 is provided. The controller 20 performs a controlling operation for displaying an image, and at the same time performs a controlling operation for touch position detection.

The controller 20 and the respective counter electrodes 21 are connected by touch sensor lines 22 extending in the Y axis direction. More specifically, the same number of the touch sensor lines 22 as the number of the counter electrodes 21 are formed on the active matrix substrate 1.

In the touch-panel-equipped display device 10 in the present embodiment, the counter electrodes 21 in pairs with the pixel electrodes, form electrostatic capacitances and are used when image display is controlled, and are also used during the control for touch position detection.

Regarding the counter electrodes 21, parasitic capacitors are formed between the same and adjacent ones of the counter electrodes 21 or the like. When a human finger or the like touches the display screen of the display device 10, capacitors are formed between the same and the human finger or the like, and electrostatic capacitances increase. During the control for touch position detection, the controller 20 supplies a sensor driving signal to the counter electrodes 21 through the touch sensor lines 22, and receives a touch detection signal through the touch sensor lines 22. By doing so, the controller 20 detects a change in the electrostatic capacitances, and detects a touch position. In other words, the touch sensor lines 22 function as lines for the transmission/reception of the sensor driving signal and the touch detection signal.

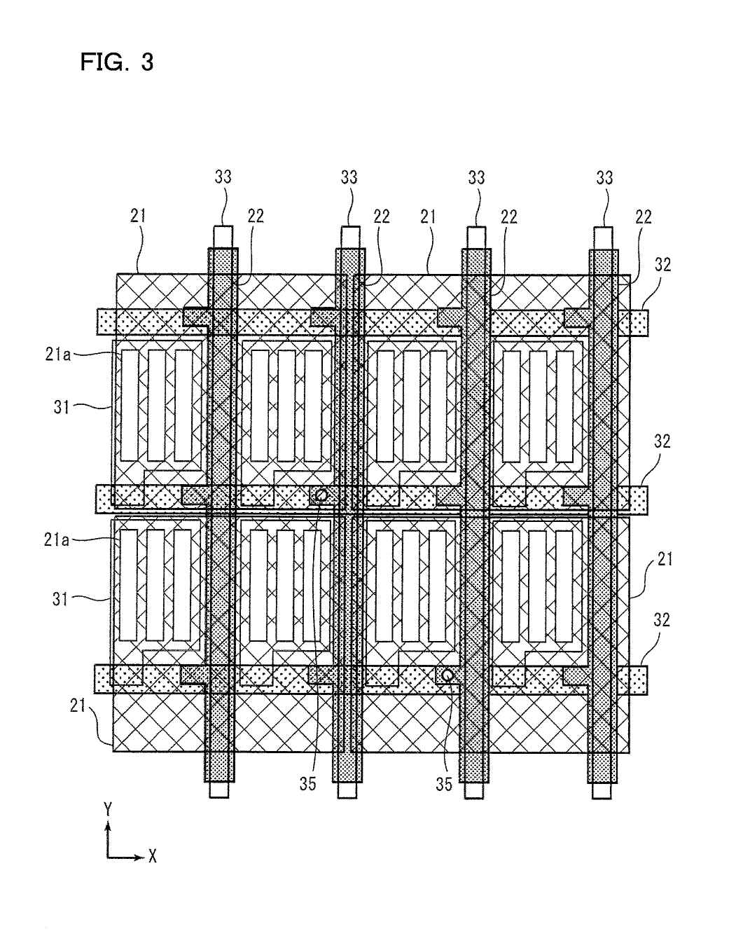

FIG. 3 is an enlarged view of a part of the area of the active matrix substrate 1. As illustrated in FIG. 3, a plurality of pixel electrodes 31 are arranged in matrix. Further, though omitted in FIG. 3, thin film transistors (TFTs) as display control elements are also arranged in matrix in correspondence to the pixel electrodes 31, respectively. The counter electrodes 21 are provided with a plurality of slits 21a.

Around the pixel electrodes 31, the gate lines 32 and the source lines 33 are provided. The gate line 32 extends in the X axis direction, and a plurality of the same are arrayed at predetermined intervals in the Y axis direction. The source line 33 extends in the Y axis direction, and a plurality of the same are arrayed at predetermined intervals in the X axis direction. In other words, the gate lines 32 and the source lines 33 are formed in a lattice form, and the pixel electrodes 31 are provided in the areas divided by the gate lines 32 and the source lines 33, respectively. The gate lines 32 and the source lines 33 are connected to the controller 20.

The same number of touch sensor lines 22 as the number of the counter electrodes 21 are provided, and the touch sensor lines 22 connect the counter electrodes 21 and the controller 20 with each other, respectively. As illustrated in FIG. 3, the touch sensor lines 22 extending in the Y axis direction are arranged so as to be partially superposed, in the normal direction with respect to the active matrix substrate 1, on the source lines 33 extending in the Y axis direction. More specifically, the touch sensor lines 22 are provided in an upper layer with respect to the source lines 33, and when viewed in a plan view, the touch sensor lines 22 and the source lines 33 are partially superposed on each other.

In FIG. 3, white circles 35 indicate portions at which the counter electrodes 21 and the touch sensor line 22 are connected with each other.

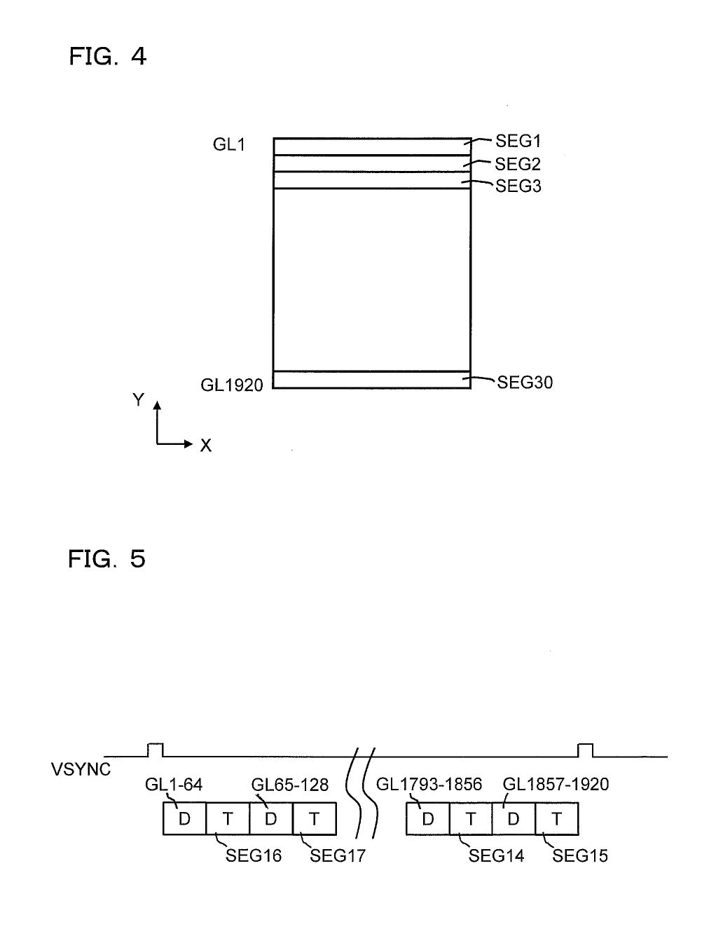

Next, the following description describes a method for driving the touch-panel-equipped display device 10 of the present embodiment, while referring to FIGS. 4 and 5. It is assumed that in the configuration described below, the number of the gate lines 32 of the touch-panel-equipped display device 10 is 1920, and the number of the counter electrodes 21 functioning as touch sensors, is 30 in the Y direction. This is however merely one example, and the number of gate lines and the number of the counter electrodes are arbitrary. Here, as illustrated in FIG. 4, the counter electrodes 21 in the touch-panel-equipped display device 10 are divided into 30 segments (SEG1 to SEG30) in the Y direction. Besides, the gate lines 32 are referred to as gate lines GL1 to GL1920.

In the touch-panel-equipped display device 10, the counter electrodes 21 are subjected to a scanning operation, in units of the above-described segments. More specifically, in one scanning operation, a sensor driving signal is supplied from the touch sensor lines 22 to the counter electrode 21 included in any one of the segments SEG1 to SEG30, and a sensor signal is read out.

FIG. 5 is a timing chart illustrating timings of a control signal supplied by the controller 20 of the touch-panel-equipped display device 10, to the gate lines 32 and the touch sensor lines 22. In FIG. 5, a period indicated by “D” is a period while an image is displayed by driving the gate lines 32. Further, a period indicated by “T” is a period while the sensor driving signal is supplied to the touch sensor lines 22 so that a touch position is detected.

As illustrated in FIG. 5, the controller 20 supplies a selection signal to the gate line GL1 and supplies a non-selection signal to the other gate lines, in synchronization with a perpendicular synchronization signal (VSYNC). This causes TFTs (display control elements) connected to the gate line GL1 to be turned ON, and to the pixel electrodes 31 connected to these TFTs, data signals in accordance with gray levels to be displayed by the pixel electrodes 31 are supplied from the source lines 33, and are written in the pixel electrodes 31.

Then, in synchronization with the next gate clock, the controller 20 supplies the selection signal to the gate line GL2, and supplies a non-selection signal to the other gate lines. This causes the TFTs (display control elements) connected to the gate line GL2 are turned ON, and data signals are supplied from the source lines 33 to the pixel electrodes 31 connected to these TFTs.

After the above-described operation is repeatedly performed until the gate line GL64 is selected, the controller 20 stops the supply of the selection signal to the gate lines 32 temporarily, and supplies a sensor driving signal to each of the counter electrodes 21 of the segment SEG16, through the touch sensor lines 22 connected to the counter electrodes 21, respectively. Then, the controller 20 receives a touch detection signal from each of the counter electrodes 21 of the segment SEG16, through the touch sensor lines 22. By this operation, the controller 20 detects a change in the electrostatic capacitance of each counter electrode 21 of the segment SEG16, thereby detecting a touch position.

In this way, when the touch position detection operation with respect to the counter electrodes 21 of the of the segment SEG16 ends, the controller 20 resumes the supply of the selection signal to the gate lines 32, in synchronization with the next gate clock. Here, the selection signal is supplied to the gate line GL65, and the non-selection signal is supplied to the other gate lines. Then, after the gate line selection operation (display operation) is performed with respect to the gate lines GL65 to GL128, the controller 20 stops the gate clock again, so as to temporarily stop the supply of the selection signal to the gate lines 32. The controller 20 then performs a touch position detection operation with respect to the counter electrodes 21 of the segment SEG17.

In this way, the controller 20 alternately and repeatedly performs the operation of selecting 64 gate lines 32, and the touch position detection operation with respect to one segment. The controller 20 completes the operation of selecting 1920 gate lines 32 and the touch position detection operation with respect to 30 segments within one vertical period.

More specifically, during one vertical period, the gate lines 32 are selected in such a manner that 64 lines are selected each time, in the order of the gate lines GL1 to GL64, the gate lines GL65 to GL128, the gate lines GL129 to GL192, . . . and the gate lines GL1857 to GL1920, with the touch position detection operation being interposed between the selection operations. In other words, the gate lines 32 are sequentially selected during one vertical period, from one end to the other end in the Y direction of the display screen.

On the other hand, the segments of the counter electrodes 21 are selected during one vertical period in such a manner that the segment SEG16 is driven first, and next, the segment SEG17, the segment SEG18, the segment SEG19 . . . are driven sequentially in the stated order. After the segment SEG30 is driven, the segments SEG1, SEG2, SEG3 . . . and SEG15 are driven sequentially in the stated order.

In other words, immediately after the gate lines GL1 to GL64, which are present at one end in the Y direction of the display screen are driven, the counter electrode 21 of the segment SEG16, which is present at a position far from these gate lines, is driven. In this way, while the image display and the touch position detection are performed alternately within one vertical period, the touch position detection operation is performed by a counter electrode that is present at a position far from the gate lines that were driven for image display immediately before it. Thereby, influences of the driving signals for the image display, on the sensor driving signal or the touch detection signal when a touch position is detected, are suppressed. In the liquid crystal display device, when a gate line is selected for image display, influences of potential fluctuations caused by the driving signal for display remain in the area, for a while after the gate line is turned to be non-selected. In the present embodiment, however, the touch position detection operation is performed at a position far from the gate line that was driven for image display immediately before the touch position detection operation, and this makes it possible to perform the touch position detection operation without being influenced by potential fluctuations due to image display.

In this embodiment, immediately after the gate lines GL1 to GL64, positioned at one end in the Y direction of the display screen, are driven, the counter electrodes 21 of the segment SEG16, positioned far from these gate lines, are driven. In other words, after the gate lines 32 of a certain group are driven, the segment of the counter electrode 21, present at a position about half screen far from these gate lines 32, is driven. The distance from the gate line 32 driven last to the segment of the counter electrode 21 driven next, however, is not limited to this, and the distance can be arbitrarily set within such a range that the touch position detection operation is not influenced by potential fluctuations of the gate lines due to image display. Generally, it is preferable that the gate line 32 driven last and the counter electrode 21 driven next are distanced from each other so that the time from the driving of the former until the driving of the latter is 1.66 msec or more.

### Embodiment 2

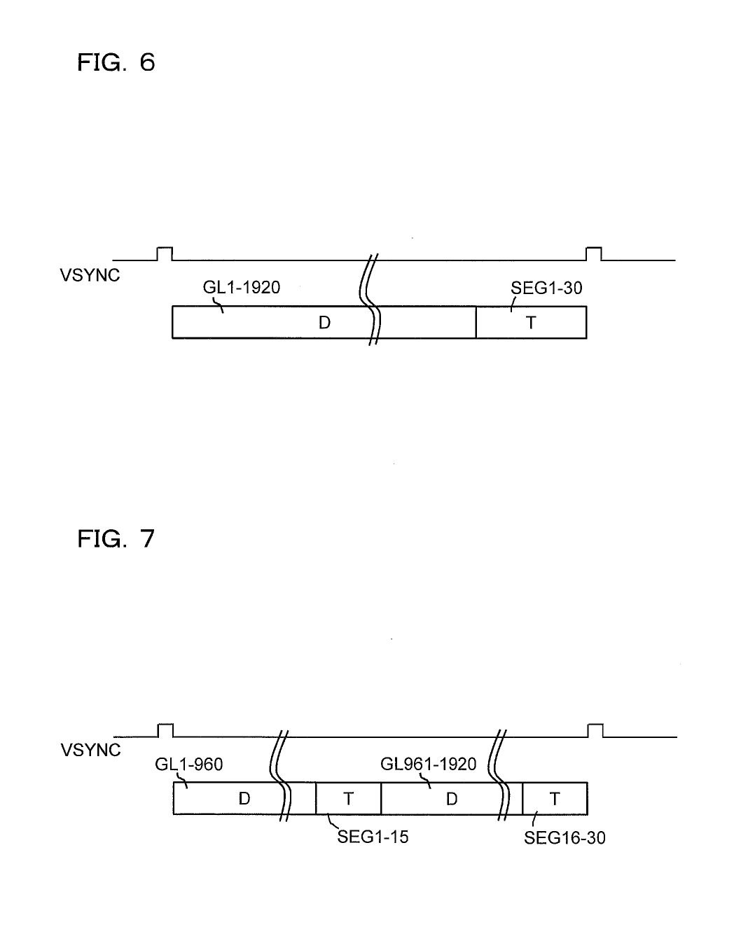

The following description describes Embodiment 2 of the present invention, while referring to FIG. 6.

A touch-panel-equipped display device 10 according to Embodiment 2 has the same configuration as that of Embodiment 1, but the driving control by a controller 20 thereof is different from that of Embodiment 1.

FIG. 6 is a timing chart illustrating timings of a control signal that the controller 20 of the touch-panel-equipped display device 10 according to Embodiment 2 supplies to gate lines 32 and touch sensor lines 22.

As illustrated in FIG. 6, the controller 20 of the present embodiment first supplies a selection signal to gate lines GL1 to GL1920 sequentially during one vertical period, so as to perform image display. Then, after supplying the selection signal to the gate line GL1920, the controller 20 stops the gate clock, and supplies a sensor driving signal to counter electrodes 21, from the segment SEG1 to the segment SEG30 in the stated order.

According to this driving method as well, when the touch position detection is performed by the counter electrodes 21 of the segment SEG1, the gate line 32 that was driven immediately before it (the gate line GL1920) is present at a position away from the segment SEG1, and therefore the touch position detection is not influenced by image display.

The position of the segment that is first driven after the gate lines GL1 to GL960 are driven, however, is not limited to the position in the above-described specific example, and the position can be arbitrarily set within such a range that the touch position detection operation is not influenced by potential fluctuations of the gate lines due to image display.

### Embodiment 3

The following description describes Embodiment 3 of the present invention, while referring to FIG. 7.

A touch-panel-equipped display device 10 according to Embodiment 3 has the same configuration as that of Embodiment 1, but the driving control by a controller 20 thereof is different from that of Embodiment 1.

FIG. 7 is a timing chart illustrating timings of a control signal that the controller 20 of the touch-panel-equipped display device 10 according to Embodiment 3 supplies to gate lines 32 and touch sensor lines 22.

As illustrated in FIG. 7, the controller 20 of the present embodiment first supplies a selection signal to gate lines GL1 to GL960 sequentially during one vertical period, so as to perform image display. Then, after supplying the selection signal to the gate line GL960, the controller 20 stops the gate clock, and supplies a sensor driving signal to counter electrodes 21, from the segment SEG1 to the segment SEG15 in the stated order.

When the touch position detection with respect to the segments SEG1 to SEG15 ends, the controller 20 resumes the supply of the selection signal to the gate lines 32, in synchronization with the next gate clock. In other words, the selection signal is supplied to the gate line GL961, and the non-selection signal is supplied to the other gate lines. Then, after the gate line selection operation (display operation) is performed with respect to the gate lines GL961 to GL1920, the controller 20 stops the gate clock again, so as to temporarily stop the supply of the selection signal to the gate lines 32. The controller 20 then performs a touch position detection operation with respect to the counter electrodes 21 of the segment SEG16. Thereafter, the touch position detection operation is performed continuously with respect to the segments SEG17 to SEG30.

According to this driving method as well, when the touch position detection is performed by the counter electrodes 21, the gate line 32 that was driven immediately before it is present at a position away from the counter electrodes 21, and therefore the touch position detection is not influenced by image display.

The position of the segment that is first driven after the gate lines GL1 to GL960, however, is not limited to the position in the above-described specific example, and the position can be arbitrarily set within such a range that the touch position detection operation is not influenced by potential fluctuations of the gate lines due to image display.

### Embodiment 4

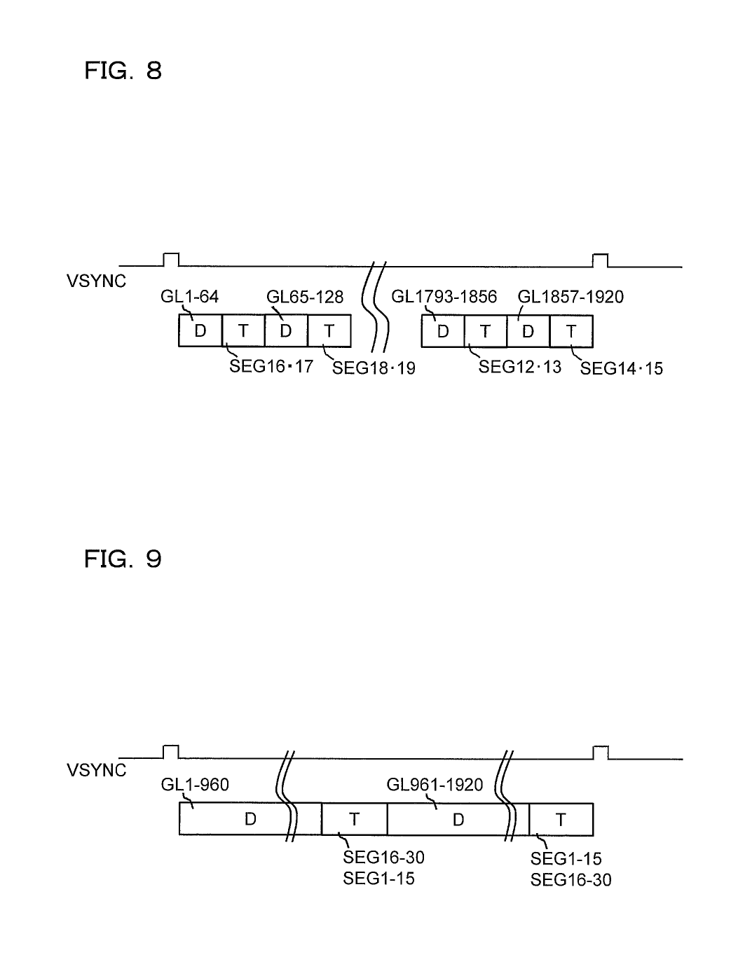

The following description describes Embodiment 4 of the present invention, while referring to FIG. 8.

A touch-panel-equipped display device 10 according to Embodiment 4 has the same configuration as that of Embodiment 1, but the driving control by a controller 20 thereof is different from that of Embodiment 1.

FIG. 8 is a timing chart illustrating timings of a control signal that the controller 20 of the touch-panel-equipped display device 10 according to Embodiment 4 supplies to gate lines 32 and touch sensor lines 22.

The touch-panel-equipped display device 10 according to the present embodiment performs the touch position detection at 120 Hz. In order to do this, it is necessary to drive all of the counter electrodes 21 (the segments SEG1 to SEG30) twice during one vertical period (60 Hz).

To do so, as illustrated in FIG. 8, the controller 20 of the present embodiment first supplies the selection signal sequentially to the gate lines GL1 to GL64 during one vertical period, so as to perform image display. Then, after supplying the selection signal to the gate line GL64, the controller 20 stops the gate clock, and supplies the sensor driving signal to the counter electrodes 21 of the segments SEG16 and SEG17 sequentially.

When the touch position detection with respect to the segments SEG16 and SEG17 ends, the controller 20 sequentially resumes the supply of the selection signal to the gate lines GL65 to GL128, in synchronization with the next gate clock. Then, after the gate line selection operation (display operation) is performed with respect to the gate lines GL65 to GL128, the controller 20 stops the gate clock again, so as to temporarily stop the supply of the selection signal to the gate lines 32. The controller 20 then performs a touch position detection operation with respect to the counter electrodes 21 of the segments SEG18 and SEG19.

Thereafter, in the same manner, the controller 20 alternately and repeatedly performs the driving of 64 gate lines 32, and the touch position detection operation with respect to two segments. This makes it possible to drive the segments SEG1 to SEG30 in two rounds during one vertical period while the 1920 gate lines 32 are driven.

Incidentally, in this example, the segments SEG16 and SEG17 are first driven after the gate lines GL1 to GL64 are driven, but the configuration may be such that the segments SEG15 and SEG16 are driven first, and thereafter the segments SEG17 and SEG18 are driven, and thereafter, the segments are sequentially driven likewise, in such a manner that 2 segments are driven each time. Further, the configuration is not limited to that of this example, and the position of the segment that is driven first after the gate lines GL1 to GL64 are driven may be arbitrarily set in such a range that the touch position detection operation is not influenced by potential fluctuations of the gate lines due to image display.

According to this driving method of the present embodiment as well, when the touch position detection is performed by the counter electrodes 21, the gate line 32 that was driven immediately before it is present at a position away from the counter electrodes 21, and therefore the touch position detection is not influenced by image display.

In this example, the counter electrodes 21 of the segments SEG1 to SEG30 are driven in two rounds during one vertical period, but the configuration may be such that the touch position detection is performed in such a manner that three or more segments are subjected to the touch position detection each time after the gate lines 32 are driven.

### Embodiment 5

The following description describes Embodiment 5 of the present invention, while referring to FIG. 9.

A touch-panel-equipped display device 10 according to Embodiment 5 has the same configuration as that of Embodiment 1, but the driving control by a controller 20 thereof is different from that of Embodiment 1.

FIG. 9 is a timing chart illustrating timings of a control signal that the controller 20 of the touch-panel-equipped display device 10 according to Embodiment 5 supplies to gate lines 32 and touch sensor lines 22.

The touch-panel-equipped display device 10 according to the present embodiment performs the touch position detection at 120 Hz. In order to do this, it is necessary to drive all of the counter electrodes 21 (the segments SEG1 to SEG30) twice during one vertical period (60 Hz).

To do so, as illustrated in FIG. 9, the controller 20 of the present embodiment first supplies the selection signal sequentially to the gate lines GL1 to GL920 during one vertical period, so as to perform image display. Then, after supplying the selection signal to the gate line GL920, the controller 20 stops the gate clock, and supplies the sensor driving signal to the counter electrodes 21 of the segments SEG16 and SEG30 sequentially, so as to detect a touch position. After the touch position detection with respect to the segment SEG30 ends, the controller 20 subsequently supplies the sensor driving signal to the counter electrodes 21 of the segments SEG1 to SEG15, so as to detect a touch position.

When the touch position detection with respect to the segment SEG15 ends, the controller 20 sequentially supplies the selection signal to the gate lines GL961 to GL1920, in synchronization with the next gate clock. Then, after the gate line selection operation (display operation) is performed with respect to the gate line GL1920, the controller 20 stops the gate clock again, so as to temporarily stop the supply of the selection signal to the gate lines 32. The controller 20 supplies the sensor driving signal to the counter electrodes 21 of the segments SEG1 to SEG15 sequentially, so as to detect a touch position. When the touch position detection with respect to the segment SEG15 ends, the controller 20 successively supplies the sensor driving signal to the counter electrodes 21 of the segments SEG16 to SEG39, so as to detect a touch position.

By this driving method of the present embodiment, the segments SEG1 to SEG30 can be driven in two rounds during one vertical period while the 1920 gate lines 32 are driven. Further, when the touch position detection is performed by the counter electrodes 21, the gate line 32 that was driven immediately before it is present at a position away from the counter electrodes 21, and therefore the touch position detection is not influenced by image display.

In the above-described specific example, the gate lines 32 are divided into two groups, and the counter electrodes 21 of all of the segments are driven after each group is driven, so that the counter electrodes 21 are driven in two rounds during one vertical period. The configuration, however, is not limited to this, and the configuration may be such that the gate lines 32 are divided into 3 or more groups, and the counter electrodes 21 of all of the segments are driven after each group is driven, so that the counter electrodes 21 are drive in three or more rounds.

The position of the segment that is first driven after the gate lines GL1 to GL960, and the position of the segment that is first driven after the gate lines GL961 to GL1920, however, are not limited to the positions in the above-described specific example, and the positions can be arbitrarily set within such a range that the touch position detection operation is not influenced by potential fluctuations of the gate line dues to image display.

### Modification Example

The above-described embodiments are merely examples for implementing the present invention. The present invention, therefore, is not limited to the above-described embodiments, and the above-described embodiments can be appropriately varied and implemented without departing from the spirit and scope of the invention.

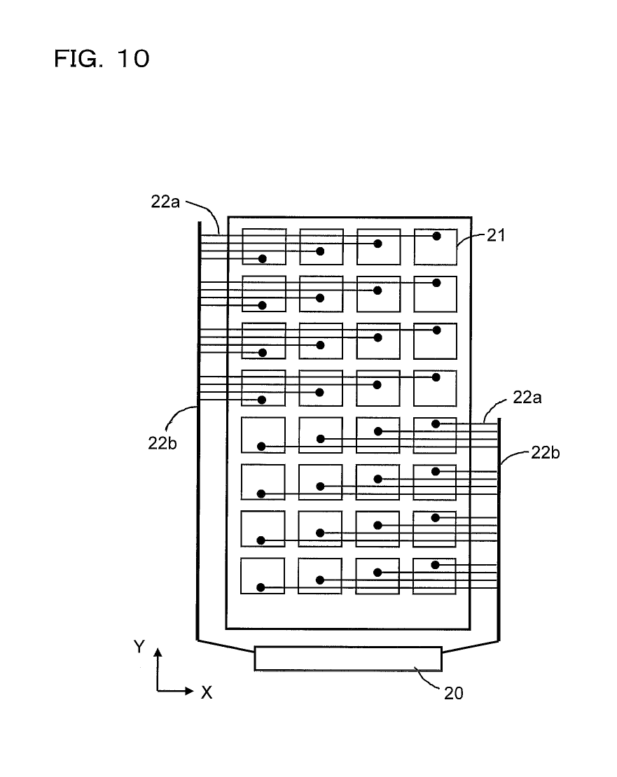

For example, FIGS. 2 and 3 illustrate an exemplary configuration in which the touch sensor lines 22 overlap with the source lines 33. In each of Embodiments 1 to 5, however, a configuration in which touch sensor lines 22a that are arranged in parallel with the gate lines 32 in the pixel region, as illustrated in FIG. 10, may be provided in place of the touch sensor lines 22. In this case, the touch sensor lines 22a are arranged in a layer other than the layer of the gate lines 32 so as to overlap with the gate lines 32 when viewed in a plan view. The touch sensor lines 22a are connected to lead-out lines 22b that extend in the Y direction outside the pixel region, and are connected to the controller 20 via these lead-out lines 22b. In this case, the controller 20 is arranged in a frame region or on an FPC substrate outside the pixel region.

Further, the above-described embodiments are described with reference to an exemplary configuration in which one controller 20 controls both of the driving of the gate lines 32 and the data lines 33 and the driving of the touch sensor lines 22, but the configuration may be such that the function of the controller 20 is divided and assigned to a plurality of circuits (IC), so that the driving of these lines is controlled by the plurality of circuits. For example, the function of the controller 20 may be divided into three that are performed by the following three circuits: a circuit that drives the gate lines 32; a circuit that drives the data lines 33; and a circuit that drives the touch sensor lines 22. Alternatively, the function of the controller 20 may be divided into two that are performed by the following two circuits; a circuit that drives the gate lines 32 and the data lines 33; and a circuit that drives the touch sensor lines 22.

### DESCRIPTION OF REFERENCE NUMERALS

1: active matrix substrate
2: counter substrate
3: liquid crystal layer
10: touch-panel-equipped display device
21: counter electrode
22, 22a: touch sensor line
22b: lead-out line
31: pixel electrode
32: gate line
33: source line

1. A touch-panel-equipped display device comprising:
an active matrix substrate;
a counter substrate opposed to the active matrix substrate; and
a liquid crystal layer interposed between the active matrix substrate and the counter substrate,
wherein the active matrix substrate includes:
a plurality of gate lines extending in a first direction;
a plurality of data lines extending in a second direction that intersects with the first direction;
display control elements connected to the gate lines and the data lines;
a plurality of pixel electrodes connected to the display control elements;
a plurality of counter electrodes that, together with pixel electrodes, form electrostatic capacitances therebetween; and
touch sensor lines connected to the counter electrodes,
the touch-panel-equipped display device further comprising:
a controller that controls a timing of supplying a sensor driving signal to the touch sensor lines, and a timing of supplying a selection signal to the gate lines,
wherein, during one vertical period, the controller performs the supply of the selection signal to the gate lines, and the supply of the sensor driving signal to the touch sensor lines, in a time-division manner,
during one scanning operation, the controller supplies the sensor driving signal to the touch sensor lines connected to the counter electrodes of one segment, among the counter electrodes, one segment being composed of a series of the counter electrodes arrayed in the first direction, and
the controller, after supplying the selection signal to at least a part of the gate lines, supplies the sensor driving signal to the touch sensor line connected to the counter electrode of the segment at a position far from the gate line to which the selection signal is supplied last.

2. The touch-panel-equipped display device according to claim 1,
wherein the number of the segments is n (n is a natural number of 2 or more), so that the counter electrodes are divided into the n segments,
the gate lines are divided into n groups, and
during one vertical period, the controller alternately performs the supply of the selection signal to the gate lines belonging to one of the groups, and the supply of the sensor driving signal to the touch sensor lines connected to the counter electrodes of one of the segments.

3. The touch-panel-equipped display device according to claim 1,
wherein, during one vertical period, after supplying the selection signal to all of the gate lines, the controller supplies the sensor driving signal to the touch sensor lines connected to the counter electrodes of the segment at the position farthest from the gate line to which the selection signal is supplied last.

4. The touch-panel-equipped display device according to claim 1,
wherein the number of the segments is n (n is a natural number of 2 or more), so that the counter electrodes are divided into the n segments,
the gate lines are divided into n groups, and
during one vertical period, the controller alternately performs the supply of the selection signal to the gate lines belonging to one of the groups, and the supply of the sensor driving signal to the touch sensor lines connected to the counter electrodes of two or more of the segments.

5. The ouch-panel-equipped display device according to claim 1,
wherein the gate lines are divided into m groups (m is a natural number of 2 or more), and
during one vertical period, the controller alternately performs the supply of the selection signal to the gate lines belonging to one of the groups, and the supply of the sensor driving signal to the touch sensor lines connected to the counter electrodes of all of the segments.
